(19) United States
(12) Patent Application Publication
(10) Pub. No.: US 2005/0279389 A1
(43) Pub. Date: Dec. 22, 2005

(54) Wet cleaning apparatus including a cover for removing impurities thereon

(76) Inventors: Yong-Myung Jun, Gyeonggi-do (KR); Jin-Suk Hong, Gyeonggi-do (KR); Ki-Yeon Chu, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/144,220

(22) Filed: Jun. 2, 2005

(30) Foreign Application Priority Data
Jun. 21, 2004 (KR) 2004-46016

(51) Int. Cl. B08B 3/04

(52) U.S. Cl. 134/25.4; 134/902; 134/135; 134/200; 134/25.1

(57) ABSTRACT

An apparatus is provided for performing a wet process to a substrate. The apparatus comprises a bath, having a top portion which defines an opening, for storing a liquid for wet processing the substrate. A cover is also provided which is movably connected to the bath at the top portion thereof. The cover includes a first face facing the opening of the bath and a second face facing away from the opening of the bath. The second face has a plurality of holes therewithin. It also contains a portion interposed between the first and second faces in communication with the holes for containing a cleaning solution. The cleaning solution is discharged through the holes from the containing portion and flows on the second face for removing any impurities from the second face.

### CROSS-REFERENCE TO RELATED APPLICATION

This application relies for priority upon Korean Patent Application No. 2004-46016 filed on Jun. 21, 2004, the content of which is herein incorporated by reference in its entirety.

### BACKGROUND OF THE INVENTION

1. Field of the Invention

The present invention relates to a wet processing apparatus for processing a substrate in a liquid, and more particularly, relates to a cover for removing impurities from a surface thereof and a wet processing apparatus including the cover.

2. Description of the Related Art

In a conventional manufacturing process for a semiconductor device, a silicon substrate such as a silicon wafer sequentially undergoes a series of processes in a plurality of processing facilities sequentially adjacent to each other for minimizing the space requirements for the facility. For example, an oxide pattern on the wafer can be formed through a series of consecutive unit processes such as coating an oxide material to thereby form an oxide layer, coating a photoresist, forming a photoresist pattern, etching the oxide layer, stripping the photoresist pattern and conducting a cleaning process.

Each of the unit processes is performed in a respective processing facility using chemical materials of its own. Each of the processing facilities is arranged adjacent to each other in a space, and the wafer is sequentially and consecutively input and output to/from the processing facilities. As a result, the oxide pattern is formed on the wafer.

In general, the processing facility includes a bath having a top portion which is open and containing a processing liquid comprising chemical materials, and a cover movably secured to the top portion of the bath. When the cover is closed, the inside of the bath is isolated from surroundings. When a wafer reaches one of the processing facilities, the cover of the processing facility is opened, and the wafer is supplied into the bath. Then, the cover is closed and the inside of the bath is isolated from surroundings. The wafer in the bath undergoes a wet process immersed in the liquid therein. When the wet process is completed, the cover of the top portion of the bath is again opened, and the wafer is removed from the bath and is introduced into a processing facility adjacent to the bath.

In general, the wafer moves from one processing facility to another processing facility as a bundle using a wafer cassette. However, when moving between the wet processing facilities, the wafer moves individually one by one without the use of a wafer cassette. Each of the wafers to be processed is individually drawn out from the wafer cassette and provided into the processing facility by a wafer transfer device, such as a robot arm. An individual processed wafer is again drawn out from the processing facility and is transferred to the next processing facility. That is, the wafer moves to a next processing facility not by in a bundle form, but individually.

However, this individual type transfer has a problem as compared with the bundle type transfer in that chemicals smeared on a surface of the wafer are dropped out onto a cover of a next processing facility during the individual transfer. The chemicals on the cover are then dropped into the processing liquid in the next processing facility and mixed therewith. As a result, the chemicals function as a contaminant source during a unit process in the next processing facility.

FIG. 1A is a view illustrating a chemical body on a cover of a conventional wet processing facility due to dropped chemicals. FIG. 1B is a view illustrating a mixing step between the chemical body on the cover and a processing liquid in a bath of the conventional wet processing facility.

As shown in FIG. 1A, when a processed wafer W that has undergone a predetermined process in a previous processing facility, and has been smeared with chemicals, is transferred over a wet processing facility by a robot arm, the chemicals C smeared on the processed wafer W can be dropped on an exterior surface of a cover 14 of the processing facility concerned and accumulated thereon. Although an amount of the chemicals C can be very small for a given wafer, the accumulated amount of the chemical C can be very substantial as wafer transfer is repeated many times. Finally, the accumulated chemicals C can grow to form a white chemical body F on the exterior surface of the cover 14 of the facility.

As shown in FIG. 1B, when the cover 14 is open for performing a process in the processing facility, the chemical body F is dropped inside the processing facility concerned and mixed with a processing liquid S. Accordingly, the processing liquid S is changed in its chemical composition, and the changed processing liquid S can cause various process failures in the processing facility concerned. Alternatively, the chemical body F may be a particle source in a wet processing in the processing facility concerned. For these reasons, a manual cleaning process for removing the chemical body F is periodically performed. However, there is still a problem in that the additional cleaning process leads to a cost increase and an efficiency reduction.

Various solutions have been attempted for mitigating the cost increase and for overcoming the efficiency reduction. For example, Japanese Patent Laid-Open Publication No. 2000-228378 discloses a nozzle for supplying a cleaning solution for removing the chemical body F from the exterior surface of the cover. The nozzle including a plurality of holes is arranged at a top portion of an exterior surface of the cover. The cleaning solution is supplied to the nozzle, and is discharged from the plurality of holes. Therefore, the cleaning solution flows down on the exterior surface of the cover, and the chemical body F is dissolved into the cleaning solution. That is, the chemical body F is washed away in the cleaning solution. Since the cleaning solution is supplied at all times or periodically/irregularly regardless of the chemical body, the chemical body on the exterior surface of the cover is removed in advance, before the chemicals C are formed into the chemical body F. As a result, the chemical body F is prevented from being formed in advance by the cleaning solution.

However, the disclosure in the above Japanese Laid-Open Patent has some problems as follows.

Since the nozzle is additionally installed at the top portion of the exterior surface of the cover, there is a problem in that a weight of the cover increases according to the amount of the nozzle weight, and the increased weight is an obstacle to the movement of the cover. Further, additional side members are added at a right angle to the nozzle along side portions of the cover for preventing the cleaning solution from flowing down to both side portions of the exterior surface of the cover. Accordingly, the weight of the cover is further increased by as much as the weight of the additional side members. In addition, there is a probability that the chemicals can accumulate on a surface of the nozzle to thereby form the chemical body F on the nozzle. The chemical body F on the nozzle may still be dropped into the bath of the processing facility.

Accordingly, there still remains the above problem of cost increase and efficiency reduction due to the chemical body in operating the wet processing facility.

### SUMMARY OF THE INVENTION

Accordingly, the present invention provides an apparatus for performing a wet process to a substrate. The apparatus comprises a bath, having a top portion which defines an opening, for storing a liquid for wet processing the substrate.

The apparatus also has a cover for efficiently and effectively removing chemicals from the exterior surface thereof. The cover is movably connected to the bath at the top portion thereof. The cover includes a first face facing toward the opening of the bath and a second face facing away from the opening of the bath.

The second face has a plurality of holes therewithin. The holes are preferably arranged in series. A containing portion is interposed between the first and second faces of the cover in communication with the holes. The containing portion can include a cleaning solution. The cleaning solution can be discharged through the holes from the containing portion and flow on the second face for removing any impurities from the second face, typically flowing down the second face. The cleaning solution preferably includes water, more preferably deionized water.

The apparatus holes are preferably arranged on the second face along the containing portion. Each of the holes preferably has a diameter of at least about 0.5 inches. More preferably, at least about fifty holes are arranged on the second face.

The cover preferably has a substantially rectangular shape including a first side secured to the bath, a second side substantially perpendicular to the first side, a third side substantially parallel with the first side and substantially perpendicular to the second side, and a fourth side substantially parallel with the second side and substantially perpendicular to the first and third sides. The containing portion is preferably positioned along and adjacent to the third side. The thickness of the cover preferably increases from a central portion thereof to the second and fourth sides, so that the cleaning solution flowing on the second face of the cover is prevented from flowing to the second and fourth sides. Stepped portions are preferably formed on the second and fourth sides of the cover at a right angle to the containing portion of the cover.

The cover can further include a reservoir for temporarily storing the cleaning solution.

The reservoir is preferably opened in a side surface of the second side of the cover.

The apparatus can further comprise a guide member connected to the reservoir, the guide member guiding the cleaning solution into the reservoir. The guide member is preferably connected with the reservoir comprises a flexible material, so that the guide member flexibly moves in accordance with a movement of the cover.

The guide member can further include a regulator for controlling an input amount of the cleaning solution. The regulator preferably includes a valve assembly having at least one manual valve.

The apparatus can further comprise a securing unit for movably securing the cover to the bath, the securing unit including a cylinder connected to the cover and a pressure member for applying a pressure to the driving cylinder. The securing unit preferably includes a position sensor for detecting a position of the cylinder to thereby detect whether the bath is open or closed by the cover. The position sensor further preferably includes a first sensor for detecting a first position of the cylinder at which the bath is closed, and a second sensor for detecting a second position of the cylinder at which the bath is open. Preferably, the position sensor includes a solenoid valve.

The cover can further include a gathering member for gathering the cleaning solution into which the impurities on the second face are dissolved. The gathering member preferably includes a groove installed along and adjacent to the first side of the cover.

### BRIEF DESCRIPTION OF THE DRAWINGS

The above and other features and advantages of the present invention will become readily apparent by reference to the following detailed description when considering in conjunction with the accompanying drawings, in which:

FIG. 1A is a view illustrating a chemical body on a cover of a conventional wet processing facility due to dropped chemicals;

FIG. 1B is view illustrating a mixing step between the chemical body on the cover and a processing liquid in a bath of the conventional wet processing facility;

FIG. 2 is a perspective view illustrating a cover for a wet processing facility according to an exemplary embodiment of the present invention;

FIG. 3A is a plan view illustrating the cover shown in FIG. 1;

FIG. 3B is a cross sectional view taken along the line I-I′ of the cover shown in FIG. 2;

FIG. 3C is a cross sectional view taken along the line II-II′ of the cover shown in FIG. 2;

FIG. 3D is a cross sectional view taken along the line III-IIII′ of the cover shown in FIG. 2;

FIG. 4 is a perspective view illustrating an apparatus for wet processing a substrate according to an exemplary embodiment of the present invention;

FIG. 5 is a perspective view illustrating the cover for the wet processing apparatus shown in FIG. 4;

FIG. 6A is a plan view illustrating the cover in FIG. 5;

FIG. 6B is a cross sectional view taken along the line I-I′ of FIG. 5;

FIG. 6C is a cross sectional view taken along the line II-II′ of FIG. 5; and

FIG. 6D is a cross sectional view taken along the line III-III′ of FIG. 5.

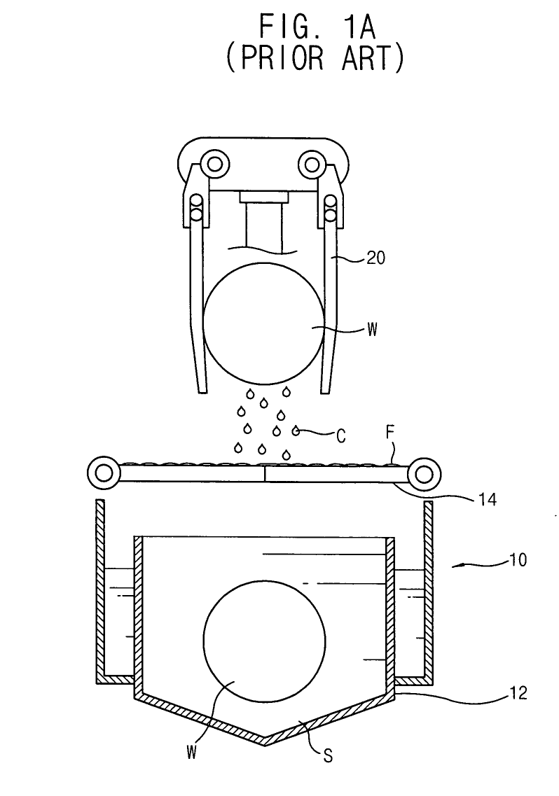

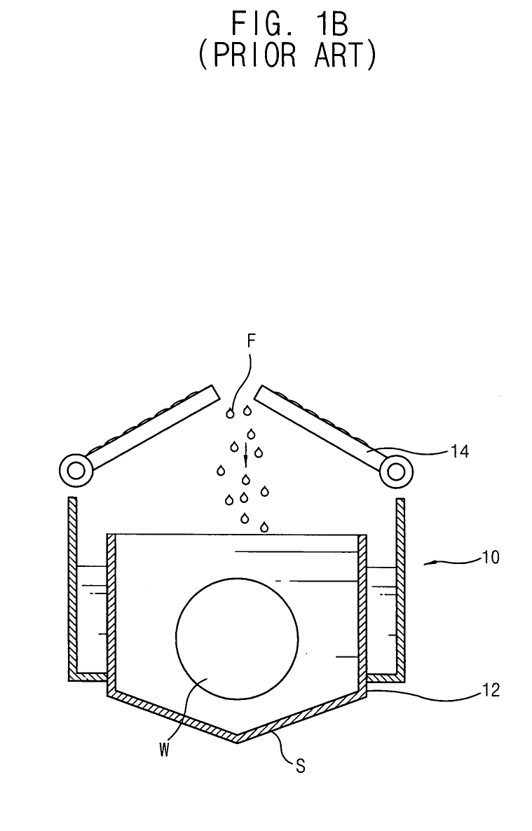

### DESCRIPTION OF THE EMBODIMENTS

The present invention now will be described more fully hereinafter with reference to the accompanying drawings in which exemplary embodiments of the present invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the thickness of layers and regions are exaggerated for clarity.

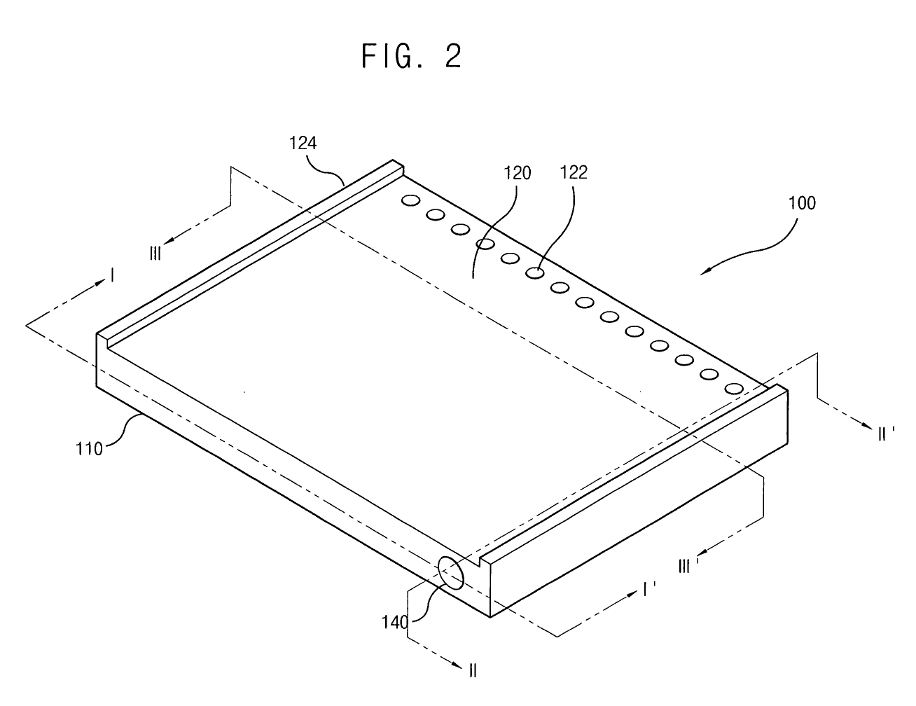

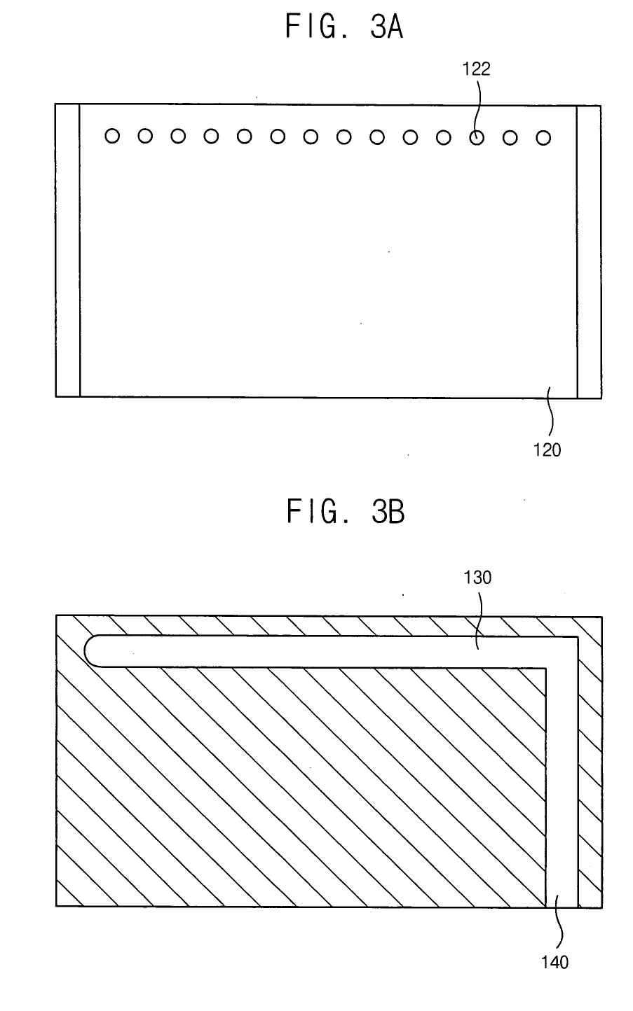

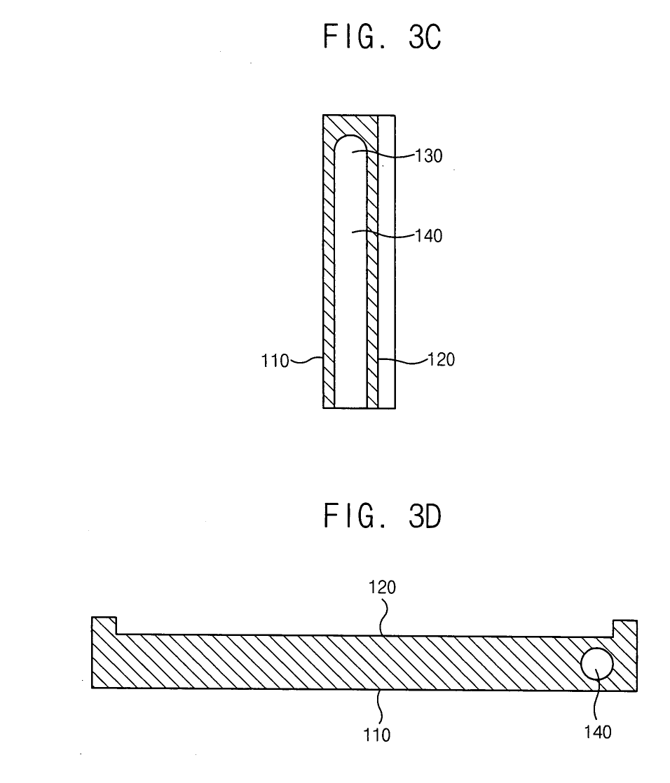

Referring to FIGS. 2 to 3D, the cover 100 for a wet processing facility according to the present invention includes a first face 110 and a second face 120, a containing portion 130 interposed between the first and second faces 110 and 120 for containing a cleaning solution, and a reservoir 140 for temporarily storing the cleaning solution.

The cover 100 is movably secured to a bath (not shown) of which a top surface is open to thereby isolating the inside of the bath from the outside thereof, and thus forming a closed space in the bath. In such a case, the first face 110 faces the closed space and the second face 120 is exposed to surroundings of the wet processing facility. In the present embodiment, the containing portion 130 is an inner space formed in the cover 100 between the first and second faces 110 and 120. A plurality of holes 122 are formed in the second face corresponding to the containing portion 130. Accordingly, the containing portion 130 forms an opening through the holes 122.

In the present embodiment, the hole has a trapezoidal shape such that an area of the hole is larger at the second surface than at the containing portion. As a result, the cleaning solution in the containing portion 130 is prevented from effusively spouting through the holes 122.

The reservoir 140 is also an inner space formed in the cover 100 between the first and second faces 110 and 120, and is connected to the containing portion 130. The reservoir 140 temporarily stores the cleaning solution before supplying the cleaning solution to the containing portion 130. That is, the cleaning solution is temporarily stored in the reservoir 140 and is supplied to the containing portion 130 of the cover 100. The cleaning solution in the containing portion 130 is discharged through the holes 122, and flows down on the second face 120.

In the present embodiment, the containing portion 130 is positioned at a first side portion of the cover 100, so that the holes 122 are also arranged in a lateral portion of the second face 120 corresponding to the first side portion of the cover 100 since the holes 122 are connected to the containing portion 130. In such a case, the holes 122 are positioned adjacent to an edge line of the second face 120 as much as possible. The reservoir 140 is also positioned at a second side portion perpendicular to the first side portion of the cover 100 adjacent to a side surface of the cover 100 as much as possible, so that the holes 122 are arranged as many as possible in series in a direction perpendicular to the reservoir 140.

As an exemplary embodiment, side portions of the cover 100 perpendicular to the containing portion 130 has a thickness greater than a central portion of the cover 100, so that the cleaning solution discharged through the holes 122 is prevented from flowing to the side portions perpendicular to the containing portion, and is guided to flow downwardly on the second face 120. In the present embodiment, a stepped portion 124 is formed on lateral portions of the second face 120 corresponding to side portions of the cover 100 perpendicular to the containing portion 130. Accordingly, the thickness of the side portions of the cover 100 is increased to an amount of the height of the stepped portion 124 compared with the thickness of the central portion of the cover 100. Although the above exemplary embodiment describes a stepped portion 124, any other modifications for a thickness gradient between the central and side portions of the cover may also be utilized in place of or in conjunction with the stepped portion 124.

The cleaning solution is supplied to the containing portion 130 of the cover 100 from an exterior source via the reservoir 140, and then the cleaning solution in the containing portion 130 is discharged through the holes 122 and flows down on the second face 120. The impurities such as chemicals on the cover 100 is dissolved by the cleaning solution and washed away from the second face of the cover 100. In such a case, the cleaning solution is prevented from flowing to the side portions of the cover 100 since the thickness is greater at the side portions than at the central portion of the cover 100. That is, the cleaning solution discharged through the holes 122 is guided to flow down in one direction on an entire second face 120. A modification to the cover shape may change the flow direction of the cleaning solution on the second face 120.

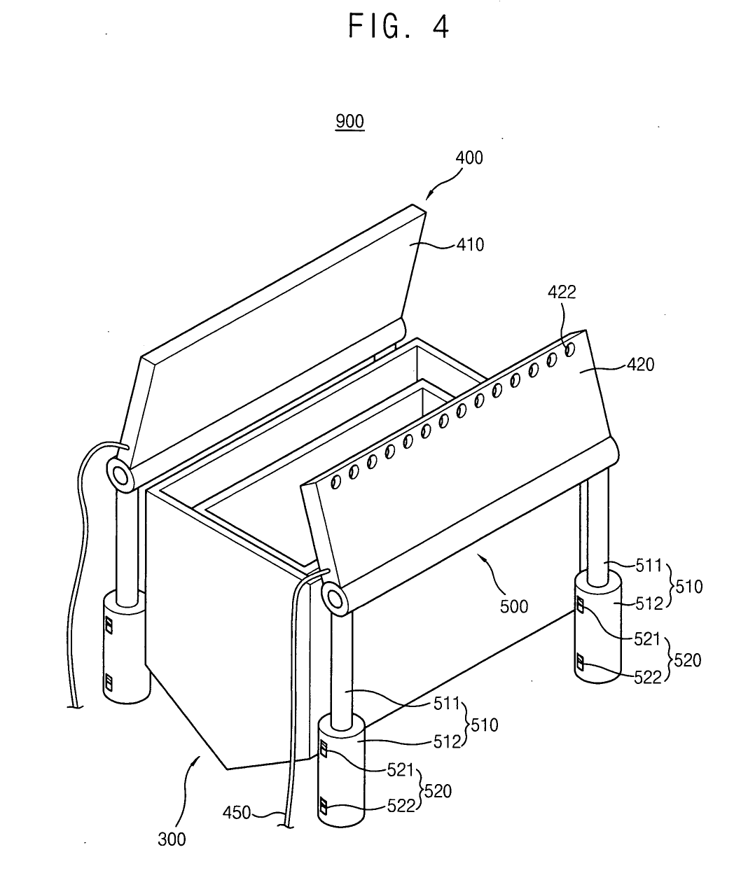

Referring to FIG. 4, the apparatus 900 for wet processing a substrate (hereinafter referred to as wet processing apparatus) includes a bath 300 of which a top portion is open and a cover 400 movably secured to the top portion of the bath 300.

The bath 300 stores a liquid for wet processing the substrate such as a silicon wafer. For example, the liquid includes an etchant for an etching process, and examples of the etchant can include an aqueous hydrogen fluoride (HF) solution, a limulus amoebocyte lysate (LAL) solution for a buffered oxide etching process, an ethylketocyclazocine (EKC) solution, an aqueous sulfuric solution (H₂SO₄), an aqueous sulfuric solution (H₃PO₄), etc.

The cover 400 is positioned on the top portion of the bath 300, and isolates an inside of the bath 300 from the surroundings to thereby form a closed space in the bath 300. Foreign matters are prevented from being supplied into the wet processing apparatus 900 during a wet process to the wafer.

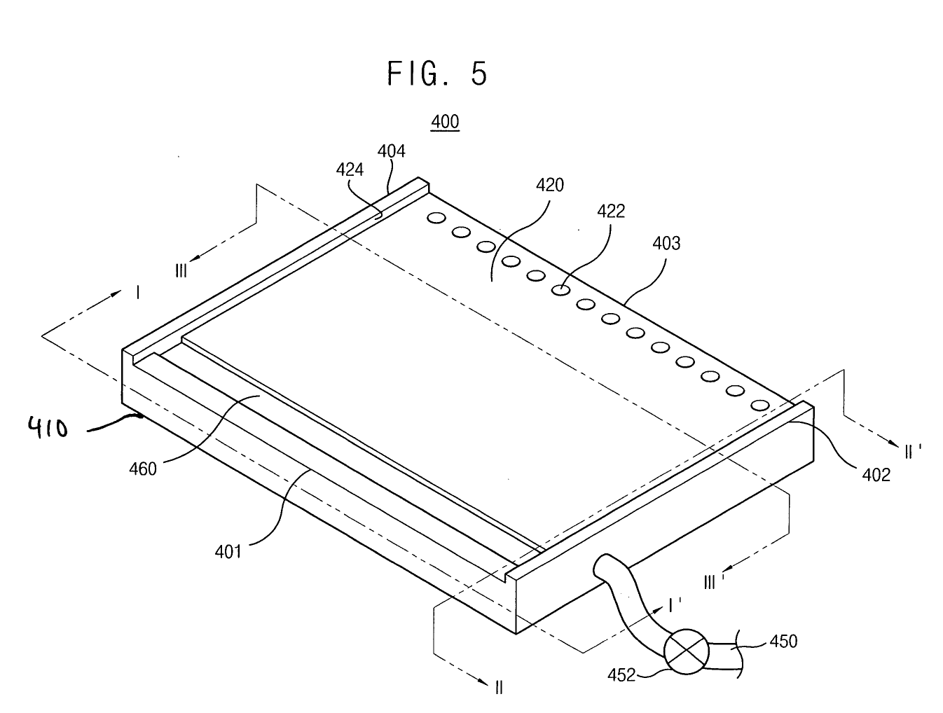

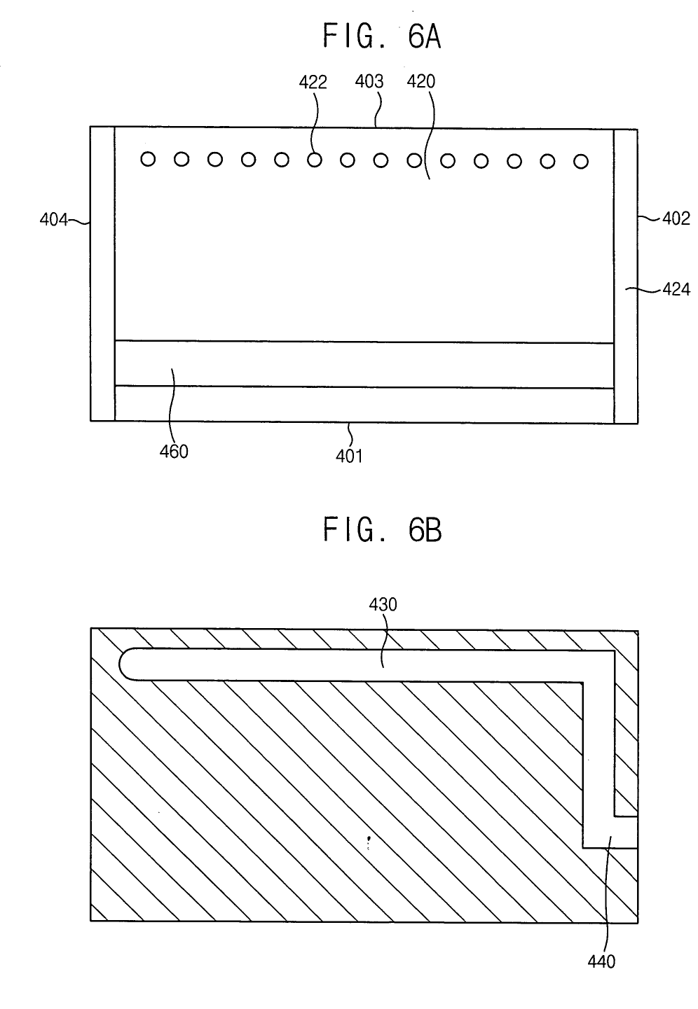

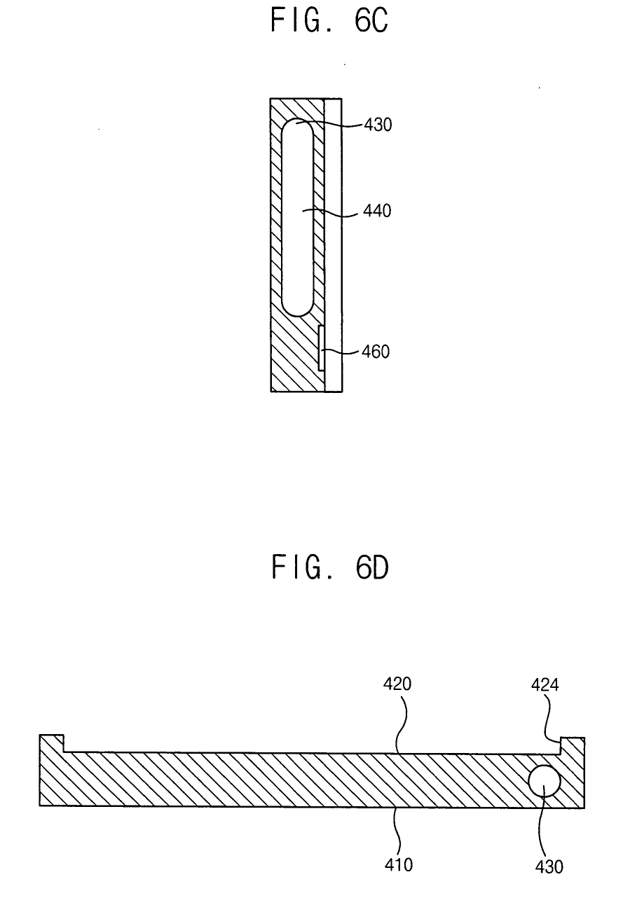

Referring to FIGS. 5 to 6D, the cover 400 includes a first face 410 facing the inside of the bath 300, a second face 420 facing the outside of the bath 300 and having a plurality of holes 422, a containing portion 430 interposed between the first and second faces 410 and 420 and connected to the holes 422 for containing a cleaning solution, and a reservoir 440 connected to the containing portion 430 for temporarily holding the cleaning solution. The cleaning solution is discharged through the holes 422 from the containing portion 430 and flows down the second face 420 for removing impurities on the second face 420.

The cover 400 is movably secured to the bath 300 of which a top surface is open to thereby isolate an inside of the bath 300 from an outside thereof, and thus a closed space is formed in the bath 300. At that time, the first face 410 faces the closed space and the second face 420 is exposed to surroundings of the wet processing apparatus 900. In the present embodiment, the containing portion 430 is an inner space formed in the cover 400 between the first and second faces 410 and 420. A plurality of the holes 422 is formed on the second face 420 corresponding to the containing portion 430. Accordingly, the containing portion 430 is partially open through the holes 422. In the present embodiment, the holes 422 exemplarily have a trapezoidal shape, so that an area of the hole 422 is larger at the second face 420 than at the containing portion 430. As a result, the cleaning solution in the containing portion 430 is prevented from effusively spouting through the holes 422. As an exemplary embodiment, at least fifty holes 422 are arranged on the second face 420, and each of the holes 422 has a diameter of about 0.5 inches. The cleaning solution includes deionized water.

The reservoir 440 is also an inner space formed in the cover 400 between the first and second faces 410 and 420, and is connected to the containing portion 430. The reservoir 440 temporarily stores the cleaning solution before supplying the cleaning solution to the containing portion 430. That is, the cleaning solution is temporarily stored in the reservoir 440 and is supplied to the containing portion 430 of the cover 400. The cleaning solution in the containing portion 430 is discharged through the holes 422, and flows down on the second face 420.

In the present embodiment, the cover 400 has a rectangular shape including a first side 401 secured to the bath 300, a second side 402 substantially perpendicular to the first side 401, a third side 403 substantially parallel with the first side 401 and substantially perpendicular to the second side 402, and a fourth side 404 substantially parallel with the second side 402 and substantially perpendicular to the first and third sides 401 and 403. The containing portion 430 is positioned along and adjacent to the third side 403, so that the holes 422 are also arranged on a lateral portion of the second face 420 along and adjacent to the third side 403 of the cover 400 since the holes 422 are connected to the containing portion 430. The holes 422 are positioned adjacent to the third side 403 as much as possible, so that the chemicals are not accumulated on the cover 400 around the third side 403.

The reservoir 440 is positioned along the second side 402 perpendicular to the containing portion 430. The reservoir 440 is also positioned adjacent to the second side 402 as much as possible, so that the holes 422 are arranged as many as possible in series in a direction perpendicular to the reservoir 440. Accordingly, the chemicals around the second side 402 are also removed in the cleaning solution discharged through the holes 422. The reservoir 440 may have an opening in a side surface of the second side 402 of the cover 400, and the cleaning solution is supplied to the reservoir 440 through the opening. Although the exemplary embodiment discusses the reservoir positioned along the second side 402 of the cover 400, the position of the reservoir 440 may be varied depending on processing conditions and limitations, as would be known to one of ordinary skill in the art.

In the present embodiment, the wet processing apparatus 900 further includes a guide member 450 connected to the reservoir 440 for guiding the cleaning solution into the reservoir 440 from an exterior source. As an exemplary embodiment, the guide member 450 comprises a flexible material, and thus flexibly moves in accordance with a movement of the cover 400. The guide member 450 is connected to the reservoir 440 at the opening on the side surface of the second side 402. The guide member 450 further includes a regulator 452 for controlling the input amount of the cleaning solution. The regulator 452 includes a valve assembly having at least one manual valve. Accordingly, the cleaning solution may be manually controlled as needed.

As an exemplary embodiment, the cover 400 can have a thickness gradient along the first 401 or the third side 403 extending from a central portion of the cover 400 to the second side 402 or the fourth side 404. In this arrangement, the cleaning solution discharged through the holes 422 is prevented from flowing to the second side 402 or the fourth side 404 perpendicular to the containing portion 430, and is guided to flow downwardly on the second face 420. The thickness gradient of the cover 400 may be continuous or discrete depending on the conditions of various processing limitations.

In the present embodiment, a stepped portion 424 is formed on lateral portions of the second face 420 corresponding to the second and fourth sides 402 and 404, respectively, of the cover 400. Accordingly, the thickness of the second and fourth sides of the cover 400 is increased to an amount of the height of the stepped portion 424 compared with the thickness of the central portion of the cover 400. The cleaning solution discharged through the holes 422 is guided to only flow toward the first side 401 of the cover 400 on the second face 420, so that the cleaning solution is prevented from being dropped into the inside of the bath 300 through the second and fourth sides 402 and 404 when the cover 400 is opened. That is, the cleaning solution is guided to flow from the third side 403 corresponding to the containing portion 430 to the first side 401.

As an exemplary embodiment, the cover 400 may further include a gathering member 460 for gathering the cleaning solution into which the impurities on the second face are dissolved. The gathering member 460 may include a groove formed along and adjacent to the first side 401 on the second face 420. The cleaning solution flows down toward the first side 401 and is gathered into the gather member 460. Then, the cleaning solution into which the chemicals are dissolved is removed from the cover 400 using an additional member (not shown).

As seen in FIG. 4, the wet processing apparatus 900 further includes a securing unit 500 for securing the cover 400 to the bath 300. In the present embodiment, the first side 401 of the cover 400 is movably secured to a side portion of the bath 300. As an exemplary embodiment, the securing unit 500 includes a connector (not shown) that is connected to the first side 401 using a gear system and a driving unit 510 for driving the gear system. The driving unit 510 transfers a driving force to the gear system, and the cover 400 rotates on its revolution axis of the first side 401 at the top portion of the bath 300. Therefore, the cover 400 is opened or closed in accordance with the rotation of the gear system. In the present embodiment, the driving unit 510 includes a driving cylinder 511 connected to the connector and a pressure member 512 for applying a driving pressure to the driving cylinder 511.

As an exemplary embodiment, the securing unit 500 further includes a position sensor 520 for detecting a position of the driving cylinder 511 to thereby detect whether the bath 300 is opened or closed by the cover 400. The position sensor 520 includes a first sensor 521 for detecting a first position of the driving cylinder 511 at which the bath 300 is closed, and a second sensor 522 for detecting a second position of the driving cylinder 511 at which the bath is opened. The position sensor exemplarily includes a solenoid valve. When the driving cylinder 511 reaches the first position, the solenoid valve is operated to thereby generate a first electrical signal. The first sensor 521 detects the first electrical signal, and thus the cover 400 is checked as closed. When the driving cylinder 511 reaches the second position, the solenoid valve is also operated to thereby generate a second electrical signal. The second sensor 522 detects the second electrical signal, and thus the cover 400 is checked as open.

A controller (not shown) systematically controls the position sensor 520, the driving unit 510 and the regulator 452. The cleaning solution is supplied to the containing portion 430 of the cover 400 from an exterior source via the reservoir 440, and then the cleaning solution in the containing portion 430 is discharged through the holes 422 and flows down on the second face 420 of the cover 400. The impurities such as chemicals on the second face 420 are dissolved into the cleaning solution and washed away from the second face 420 of the cover 400. In such a case, the cleaning solution is prevented from flowing to the second and fourth sides 402 and 404, since the thickness of the second and fourth sides 402 and 404 is greater than that of the central portion of the cover 400. That is, the cleaning solution discharged through the holes 422 is guided to flow down toward the first side 401 on a whole second face 420, so that the cleaning solution including the chemicals is prevented from flowing into the bath 300. The cleaning solution is gathered into the gathering member 460, and then removed from the cover 400. When the cover 400 is again closed, the manual valve of the regulator 452 is closed to thereby stop the supply of the cleaning solution.

According to the present invention, the impurities such as chemicals on an exterior surface of the cover for a wet processing apparatus are removed whenever the cover is opened, and thus the impurities are prevented from growing into a mass such as a chemical body. As a result, an additional process for removing the chemical body is not required anymore, and thus the time and cost for wet processing is remarkably reduced.

Although the exemplary embodiments of the present invention have been described, it is understood that the present invention should not be limited to these exemplary embodiments but various changes and modifications can be made by one skilled in the art within the spirit and scope of the present invention as hereinafter claimed.

1. A cover for a wet processing facility, comprising:
a first face facing toward inside of a bath of the wet processing facility;
a second face facing toward outside of the bath of the wet processing facility;
a plurality of holes formed in the second face; and
a containing portion interposed between the first and second faces and in communication with the holes for containing a cleaning solution;
the cleaning solution being discharged through the holes from the containing portion and flowing on the second face for removing impurities from the second face.

2. The cover of claim 1, wherein the holes are arranged on the second face along the containing portion.

3. The cover of claim 2, wherein an area of the hole is larger at the second surface than at the containing portion.

4. The cover of claim 1, further comprising a reservoir for temporarily storing the cleaning solution.

5. The cover of claim 1, wherein a thickness of the cover increases from a central portion thereof to a lateral portion thereof, so that the cleaning solution flowing on the second face is prevented from flowing to a lateral side of the second face.

6. The cover of claim 1, wherein a stepped portion is formed on a lateral side of the second face.

7. An apparatus for performing a wet process to a substrate, comprising:
a bath, having a top portion which defines an opening, for storing a liquid for wet processing the substrate; and
a cover movably connected to the bath at the top portion thereof, the cover including a first face facing toward the opening of the bath, a second face facing away from the opening of the bath, the second face having a plurality of holes therewithin, and a containing portion interposed between the first and second faces in communication with the holes for containing a cleaning solution;
the cleaning solution being discharged through the holes from the containing portion and flowing on the second face for removing impurities from the second face.

8. The apparatus of claim 7, wherein the holes are arranged on the second face along the containing portion.

9. The apparatus of claim 8, each of the holes has a diameter of at least about 0.5 inches.

10. The apparatus of claim 7, wherein the cover has a substantially rectangular shape including a first side secured to the bath, a second side substantially perpendicular to the first side, a third side substantially parallel with the first side and substantially perpendicular to the second side, and a fourth side substantially parallel with the second side and substantially perpendicular to the first and third sides, and the containing portion is positioned along and adjacent to the third side.

11. The apparatus of claim 7, wherein the cover further includes a reservoir for temporarily storing the cleaning solution.

12. The apparatus of claim 11, wherein the reservoir is opened in a side surface of the second side of the cover.

13. The apparatus of claim 11, further comprising a guide member connected to the reservoir, the guide member guiding the cleaning solution into the reservoir.

14. The apparatus of claim 13, wherein at least a portion of the guide member connected with the reservoir comprises a flexible material, so that the guide member flexibly moves in accordance with a movement of the cover.

15. The apparatus of claim 13, wherein the guide member further includes a regulator for controlling an input amount of the cleaning solution.

16. The apparatus of claim 15, wherein the regulator includes a valve assembly having at least one manual valve.

17. The apparatus of claim 10, wherein a thickness of the cover increases from a central portion thereof to the second and fourth sides, so that the cleaning solution flowing on the second face of the cover is prevented from flowing to the second and fourth sides.

18. The apparatus of claim 17, wherein stepped portions are formed on the second and fourth sides of the cover at a right angle to the containing portion of the cover.

19. The apparatus of claim 7, further comprising a securing unit for movably securing the cover to the bath, the securing unit including a cylinder connected to the cover and a pressure member for applying a pressure to the driving cylinder.

20. The apparatus of claim 19, wherein the securing unit further includes a position sensor for detecting a position of the cylinder to determine whether the bath is open or closed by the cover.

21. The apparatus of claim 20, wherein the position sensor includes a first sensor for detecting a first position of the cylinder at which the bath is closed, and a second sensor for detecting a second position of the cylinder at which the bath is open.

22. The apparatus of claim 20, wherein the position sensor includes a solenoid valve.

23. The apparatus of claim 7, wherein the cover further includes a gathering member for gathering the cleaning solution into which the impurities on the second face are dissolved.

24. The apparatus of claim 23, wherein the gathering member includes a groove installed along and adjacent to the first side of the cover.

25. The apparatus of claim 7, wherein the cleaning solution includes water.

26. A method for cleaning a cover for a wet processing facility, comprising:
providing a cover including a first face facing toward inside of a bath of the wet processing facility, a second face facing toward outside of the bath of the wet processing facility, a plurality of holes formed in the second face, and a containing portion interposed between the first and second faces and in communication with the holes for containing a cleaning solution; and
discharging the cleaning solution through the holes from the containing portion and flowing on the second face for removing impurities from the second face.

27. An method for cleaning a cover of a bath during performing a wet process to a substrate, comprising:
providing a bath, having a portion which defines an opening, for storing a liquid for wet processing the substrate; and
providing a cover movably connected to the bath at the top portion thereof, the cover including a first face facing toward the opening of the bath, a second face facing away from the opening of the bath, the second face having a plurality of holes therewithin, and a containing portion interposed between the first and second faces in communication with the holes for containing a cleaning solution;
discharging the cleaning solution through the holes from the containing portion and flowing on the second face for removing impurities from the second face.

28. A cover for a wet processing facility, comprising:
a first face facing toward inside of a bath of the wet processing facility;
a second face facing toward outside of the bath of the wet processing facility;
a plurality of holes formed in the second face; and
a containing portion interposed between the first and second faces and in communication with the holes for containing a cleaning solution.
